(19) United States
(12) Patent Application Publication
(10) Pub. No.: US 2015/0302270 A1
(43) Pub. Date: Oct. 22, 2015

(54) A METHOD OF PROVIDING A FEATURE DESCRIPTOR FOR DESCRIBING AT LEAST ONE FEATURE OF AN OBJECT REPRESENTATION

(71) Applicants: Selim BenHimane, Milpitas, CA (US); Thomas Olszamowski, München (DE)

(72) Inventors: Selim BenHimane, Milpitas, CA (US); Thomas Olszamowski, München (DE)

(73) Assignee: Metaio GmbH, Munich (DE)

(21) Appl. No.: 14/420,226

(22) PCT Filed: Aug. 7, 2012
(86) PCT No.: PCT/EP2012/065441

§ 371 Date: Jun. 17, 2015

(51) Int. Cl. G06K 9/46

(52) U.S. Cl. CPC G06K 9/4671

(57) ABSTRACT

A method of providing a feature descriptor for describing at least one feature of an object representation includes the steps of providing an original feature descriptor comprising at least one vector or a plurality of K vectors having equal sum of vector entry values and each vector having H entries, projecting each vector on a lower dimensional space of size H-1 or lower to gain a projected feature descriptor comprising projected vectors of H-1 entries or lower, such that it is possible to obtain a similarity measure between two projected feature descriptors equal to the similarity measure between the two corresponding original feature descriptors, and providing the projected feature descriptor as a lossless compressed feature descriptor.

This application is entitled to the benefit of, and incorporates by reference essential subject matter disclosed in PCT Application No. PCT/EP2012/065441 filed on Aug. 7, 2012.

### BACKGROUND OF TEM INVENTION

1. Technical Field

The invention is related to a method of providing a feature descriptor for describing at least one feature of an object representation, and a corresponding computer program product for performing the method. Further, the invention is related to a corresponding feature descriptor.

2. Background Information

Feature matching is one of the most important parts, for example in vision-based camera localization, visual tracking, object recognition, object model alignment, sensor registration, object classification or visual search. Many approaches have been proposed and the most used ones are based on feature detection or extraction from a certain object representation followed by feature description. Examples of such object representations, which are also applicable in connection with the following described present invention, can be (but are not restricted to) one or multiple images captured by one or multiple cameras, one or multiple Computer Aided Design models also known as CAD models describing the object, one or multiple drawings or blue prints of the objects, one or multiple sounds characterizing the object, one or multiple images from a depth camera, one or multiple images captured by one or multiple time-of-flight cameras also known as TOF cameras, or any representation obtained with any of combination of the above possible representations.

In the case of camera images or drawing or blue prints the features can, for example, be (but are not restricted to) a plurality of corners, contours, edge points, extrema in differential of Gaussians, center of rotational invariant or affine invariant regions, region with a specific color or combination or function derived or computed using colors. In the case of CAD model or an image from a depth camera or an image from a TOF camera or a set of images from a multi-camera system, the features can additionally be (but are not restricted to) 3D points with high gradient in the surface normal vectors, discontinuities in the surface, shapes or well-defined geometries. In the case of sound any feature obtained from signal processing such as gradients extrema could be used for the matching.

The above mentioned and any following examples and exemplary implementations are also applicable in connection with the present invention described in more detail below.

In order for a better understanding and clarity, the following exemplary description focuses on the special case of visual representation of the object, but all the following description and reasoning hold for any object representation such as the representations cited above.

In the case when the object representation is an image captured by a camera, feature matching approaches that consists of associating features based on the result of similarity measures (or distances) work as follows.

In a set of reference images, reference features (corners, contours, edge points, extrema in differential of Gaussians, center of rotational invariant or affine invariant regions, etc.) are detected in an offline stage. The feature detection is performed for identifying features in an image by means of a method that has a high repeatability. The method is selected such that the probability is high that it detects the part in an image corresponding to the same physical 3D surface as a feature for different viewpoints, different rotations and/or illumination settings (e.g. local feature descriptors as scale invariant feature transform “SIFT”; e.g., see D. G. Lowe. Distinctive image features from scale-invariant keypoints. Int. Journal on Computer Vision, 60(2):91-110, 2004. or other approaches known to the skilled person).

The features are described using in most cases descriptors stored into vectors of a certain size DS (DS=descriptor size). The descriptors can be very simple such as describing the intensities of the pixels in the region around the detected features, or can he based on function of local image intensities as the concatenation of the histograms of the gradient orientations in sub-regions around the feature.

In most proposed descriptors, in order to gain invariance to viewpoint and/or illumination changes, the computation of the descriptor is preceded by a photometric and/or geometric normalization of the region around the feature. The photometric normalization can be done e.g. by subtracting the mean of the pixel intensity from the pixel intensities, or by image histogram equalization of the region around the feature that is used to compute the descriptor. The geometric normalization can be done e.g. by applying a rotation (computed using the dominant direction of intensity gradients in the region) and/or a scale and/or an affine image transformation (see different possible affine rectifications in K. Mikolajczyk, T. Tuytelaars, C. Schmid, A. Zisserman, J. Matas, F. Schaffalitzky, T. Kadir, and L. V. Gool. A comparison of affine region detectors. Int. Journal Computer Vision, 65:43-72, 2005). For the same physical region imaged from different viewpoints and/or lighting conditions, the normalization procedure would ideally result into a very similar normalized region which ends up to a very similar descriptor.

Current features are extracted from object representations, such as current images, that can be query images or live captured images in a similar way. Given a current feature detected in and described from an object representation, such as a current image, the matching basically comprises finding a reference feature that corresponds to the same physical. 3D surface in the set of reference features. The simplest approach to feature matching is to find the nearest neighbor of the current feature's descriptor in the set of the reference feature descriptors by means of exhaustive search and choose the corresponding reference feature as a match. More advanced approaches employ spatial data structures in the descriptor domain to speed up matching. There are other ways of speeding up the matching like replacing the exact nearest neighbor algorithm with an approximate nearest neighbor algorithm, or in some cases it is possible to take advantage of some properties of the similarity/feature descriptor distance measure to speed up the matching, e.g. in case the similarity measure used is the sum-of-squared differences (SSD) of the descriptor vector using the mean-bound SSD algorithm improves the matching speed E. Rosten. High performance rigid body tracking. PhD thesis, University of Cambridge. February 2006.

Since some of the targeted applications would need to run in real-time and/or computational power and memory restricted devices (such as mobile devices, smart phones, tablets, etc.), the feature detection, description and matching would need to be efficient in terms of computational costs and memory consumption. Additionally, in some applications, the feature descriptors are transferred wirelessly (downloaded from internet, sent from a local server or remote server, etc.) which means that the transfer time varies according to the number of features and the number and the size of their descriptors.

Many descriptors have been proposed in the literature: Scale Invariant Feature Transform (SIFT) D. G. Lowe. Distinctive image features from scale-invariant keypoints. Int. Journal on Computer Vision, 60(2):91-110, 2004, Speed-up Robust Feature (SURF) H. Bay, A. Ess, T. Tuytelaars, L. Van Gool. SURF: Speeded Up Robust Features”, Computer Vision and Image Understanding (CVIU), Vol. 110(3):346-359, 2008, Histogram of Oriented Gradient (HOG) [5], Local Binary Pattern (LBP), T. Ojala, M. Pietikainen, T. Maenpaa. Multiresolution gray-scale and rotation invariant texture classification with local binary patterns. IEEE Transactions on Pattern Analysis and Machine Intelligence 24 (2002) 971-987. Most of these recent descriptors are based on histogram-based vector computations. While some feature descriptors are relatively slow (computationally expensive), inefficient (large memory requirement) and not suited for real-time applications, some others are designed to provide very good results in a relatively fast and efficient way. The LBP is one of the fastest and one of the most efficient local feature descriptor.

Given a reference image or a current image, histogram-based visual feature descriptor vectors, for example, can be generated as follows:
Extract features corresponding to pixel locations or a set of pixel locations in the image,
Select a region of interest around a feature,
Divide the region of interest into K sub-regions with equal number N of pixels,
For every sub-region, compute a histogram corresponding to a vector of size H (vector with H entries) containing finite values obtained with a function ƒₘ operating on the intensity value of a fixed or variable set of neighbors of every pixel in the sub-region, e.g.
   The function can be based on simple intensity comparisons e.g.
      for every pixel in the sub-region, perform M comparisons between the intensity value of two neighboring image pixels and provide a binary answer, for all m ∈ [[1, M]]:

$${f}_{m} ( p {1}_{m} , p {2}_{m} ) = \{ \begin{matrix}0 , & I ( p {1}_{m} ) < I ( p {2}_{m} ) \\ 1 , & I ( p {1}_{m} ) \geq I ( p {2}_{m} )\end{matrix}$$

for every pixel in the sub-region, perform M comparisons between the intensity value of two neighboring image pixels and provide a ternary answer, for all m ∈ [[1, M]]:

$${f}_{m} ( p {1}_{m} , p {2}_{m} ) = ( \begin{matrix}0 , & I ( p {1}_{m} ) + ɛ < I ( p {2}_{m} ) \\ 1 , & I ( p {1}_{m} ) > I ( p {2}_{m} ) + ɛ \\ 2 , & else\end{matrix}$$

The M comparisons result into H=C^{M} possible results where e.g. C=2 the binary comparisons C=3 in the case of ternary comparisons (all possible combinations).
The function can be based on binned gradient orientations, e.g. H would be the total number of orientation bins and the first bin of the histogram would contain the number of pixels in the sub-region that have a gradient orientation between 0 and

$$\frac{2 π}{H} ,$$

the second bin would contain the number of pixels in the sub-region that have a gradient orientation between

$$\frac{2 π}{H} and \frac{4 π}{H} ,$$

. . . the last bin would contain the number of pixels in the sub-region that have a gradient orientation between

$$\frac{2 π ( H - 1 )}{H}$$

and 2π.

Note that the sum of all histogram bins of all sub-regions is equal to N which is the total number of the pixel in every sub-region. We call this property “the inherent sum constraint”.

Many possible functions operating on the intensity value of a fixed/variable set of neighbors of every pixel in the sub-region could be used. This can also be preceded by applying to the original image any morphological local or global image operation such as applying image gradient filter, image synthetic blurring, image de-noising, image smoothing, image histogram enhancement.
The concatenation of the K histograms gives the descriptor. The size of the descriptor vector is DS=K*H.

Given a set of reference features rᵢ to which at least one reference descriptor dr_{i,a} (where i is varying between 1 and Nr and a>0) is associated and a set of current features cⱼ to which at least one current descriptor dc_{j,b} (where j is varying between 1 and Nc and b>0) is associated, the matching process is based on computing a similarity measure between the reference descriptors and the current descriptors. The similarity measure SM between the reference descriptor dr_{i,a} and the current descriptor dc_{j,b} can be based on the Euclidean distance:

SM(dr_{i,a}, dc_{j,b})=Σₛ₌₁^{DS}(dr_{i,a}(s)−dc_{j,b}(s))²

It can also be any other similarity measure between two vectors of the same size like the Manhattan distance SM(dr_{i,a}, dc_{j,b})=Σₛ₌₁^{DS}|dr_{i,a}(s)−dc_{j,b}(s)| or correlation value, etc.

From the description above, it can be seen that the required memory of the storage of the descriptor is proportional to DS=K*H where K is the number of sub-regions around the extracted feature and H is the histogram size. Depending on the application, this can amount to a considerable descriptor size and computation, also with respect to a matching process using such descriptors. Since some of the targeted applications would need to run in real-time and/or computational power and memory restricted devices (such as mobile devices, smart phones, tablets, etc.), the feature detection, description and matching could be critical on such devices in terms of computational costs and memory consumption. As a consequence, a matching process using such descriptors may hardly be feasible, e.g. in real-time applications on a mobile device.

It would therefore be beneficial to provide a method of providing a feature descriptor for describing at least one feature of an object representation, which is capable of being used in computer-based applications as stated above for operating such applications in real-time, and/or on computational power and/or memory restricted devices.

### SUMMARY OF THE INVENTION

Aspects of the invention are provided according to the independent claims.

According to an aspect, there is provided a method of providing a feature descriptor for describing at least one feature of an object representation, comprising the steps of:
a) providing an original feature descriptor comprising at least one vector or a plurality of K vectors having equal sum of vector entry values and each vector having H entries,
b) projecting each vector on a lower dimensional space of size H−1 or lower to gain a projected feature descriptor comprising projected vectors of H−1 entries or lower, such that it is possible to obtain a similarity measure between two projected feature descriptors equal to the similarity measure between the two corresponding original feature descriptors,
c) providing the projected feature descriptor as a lossless compressed feature descriptor.

For example, said object representation is an image of a camera, a CAD model, a drawing, a sound, an image from a depth camera, an image of a time-of-flight camera, or a set of images from a multi-camera system. Particularly, the method is implemented on a computer system and may be used on computer devices, such as mobile devices like mobile phones. Likewise, the provided feature descriptors may be used in an application on a computer system and, for example, on such mobile devices.

According to an aspect, it is thus proposed to project standard histogram-like-based feature descriptor vectors of an object representation on a lower dimensional space, particularly by taking advantage of “the inherent sum constraint”, as described above. The proposed projection reduces the size of the descriptor in a lossless way. This means that the proposed projection does not affect the distance measurement, i.e. the projection allows getting smaller descriptor vectors with the same quality in the matching.

The reduction of the descriptor size has a direct positive influence on the memory efficiency since a smaller amount of information need to be stored per feature descriptor. Another direct positive influence concerns the speed up in the matching process since a smaller number of operations are needed to compute the distance between two feature descriptor vectors. Moreover, the nearest neighbor search performed during the matching process can be further speeded-up thanks to the obtained projected version of the feature descriptors that do not present “the inherent sum constraint”.

Referring to the above described exemplary generation of histogram-based visual feature descriptor vectors, by definition, the sum of the values of the histograms in every sub-region K is equal to N. The inventors of the present invention have found that there is some redundant information stored in such descriptor. This redundant information can be seen as follows: say, the last bin of every sub-region histogram can be computed using the values of the rest of the bins, i.e. for the descriptor vector d we have: for all k ∈ [[1, K]]:

d(k*H)=N−Σₛ₌₁^{H-1}d((k−1)*H+s)

Accordingly, the standard approaches as described above are storing redundant information in the descriptors.

According to the present invention, it has been found that it is therefore possible to skip or dismiss one bin of the local histogram when storing the descriptors (as explained above we consider this as redundant information) and re-compute the skipped or dismissed bins using a similar formula as above during the matching process. Another possible approach is to transform the feature descriptor vector in a lower dimensional space in such a way to keep an equal influence of every histogram bin in a distance computation of a succeeding matching process.

The computational time of the similarity measure is also proportional to the descriptor size DS. However, above we showed that there is redundant information in the descriptor. It should then be possible to compute the similarity measure with omitting the redundant information.

Thus, according to the invention, the size of the standard histogram-like-based feature descriptors is reduced by taking advantage of “the inherent sum constraint”. The reduction of the descriptor size has a direct positive influence on the memory efficiency, since only part of the standard histogram-like-based feature descriptors needs to be stored. The obtained truncated feature descriptor requires a fraction (H−1)/H of the original descriptor size.

To avoid any unbalanced influence of the remaining feature vector entries (or, in a particular implementation, histogram bins) in the distance computation which causes distortion in the distance measurements, a transformation of the truncated feature descriptor that corrects the distortion is performed. The transformation assures that the distance computation gives the same results as the original (standard) non-truncated version (that is, the invention provides a lossless size reduction of a histogram-based feature descriptor), but with a faster nearest neighbor-based matching.

It is shown that the obtained descriptor could additionally benefit from extra speedup approaches as the one presented in E. Rosten. High performance rigid body tracking. PhD thesis, University of Cambridge. February 2006.

The obtained descriptors could be used, for instance, in vision-based camera localization, visual tracking, object recognition, object classification or visual search. In the case of using such descriptors in server-based image recognition or visual search approach, the size reduction of the visual feature descriptors allows decreasing the download time and overcoming some of the network or bus bandwidth limitations since the lossless visual feature descriptor size reduction allows having smaller feature descriptor file sizes with keeping the same performance in terms of robustness.

The proposed invention allows loading in the computer device local memory a larger number of feature descriptors to be matched against a live camera image. Therefore, the slow communication between either the hard drive or the server containing the database of the feature descriptors and the local memory can be reduced allowing a faster recognition or classification. This improves the quality of the user experience.

In the case of large scale tracking or large database image classification, the proposed invention tackles the two major bottlenecks that are the feature descriptor size and the matching speed without affecting the quality or the robustness of the matching results.

According to an embodiment, said object representation is an image of a camera, and the above described step a) comprises the steps of:
aa) extracting at least one feature from the image,
ab) selecting a region of interest around the extracted feature,
ac) dividing the region of interest into one sub-region or K sub-regions,
ad) for every sub-region, computing a respective vector of H entries,
ae) providing one vector or K vectors as the original feature descriptor for the extracted feature.

Step ac) may include dividing the region of interest into K sub-regions with equal number N of pixels, and in the feature descriptor vector created in step ae) the sum of the values of all the entries of each vector in every sub-region is equal to N.

According to an embodiment, step ad) comprises computing a respective vector of H entries containing values obtained with a function operating on an intensity value of a set of neighbors of a plurality of pixels in the respective sub-region.

Before computing the function results, any morphological image operation or filter, particularly like image gradient, image synthetic blurring, image de-noising, image smoothing, or image histogram enhancement, or similar, may be applied.

For example, the function is based on intensity comparisons for pixels in the respective sub-region.

For instance, the function is based on binned gradient orientations with each of a plurality of entries of the respective vector containing a number of pixels in the respective sub-region that have a particular gradient orientation.

According to a particular embodiment, step b) comprises dismissing at least one entry of each of the K vectors, wherein the number of entries of the obtained truncated feature descriptor vector becomes K*(H−1) or less.

For example, in a subsequent similarity measure computation during the matching process the dismissed entry of each vector is recomputable.

According to another embodiment, step b) comprises transforming the feature descriptor vector in such a way to correct any distortion caused by the projecting of the feature descriptor vector on a lower dimensional space.

For example, step b) comprises transforming the feature descriptor vector in such a way to keep an equal influence of every vector entry in a similarity measure computation of a succeeding matching process.

According to an embodiment, step b) includes the following steps:
providing a vector v₁ in R^{H} where

$${v}_{1} = {\frac{1}{\sqrt{H}} [ 1 \; 1 \; 1 … 1 ]}^{T} ,$$

wherein the vector v₁ defines an affine hyperplane of co-dimension 1, and providing a vector p lying on such hyperplane, wherein p verifies:

$${v}_{1}^{T} \cdot p - \frac{N}{\sqrt{H}} = 0$$

completing the vector v₁ by a set of H−1 orthonormal vectors vᵢ in order to obtain an orthonormal basis of the R^{H} which is the real H dimensional vector space, particularly using the Gram-Schmidt process,
using the vectors vᵢ in projecting the feature descriptor vector on a lower dimensional space spanned by vᵢ where i ∈ [2, H].

In a further embodiment, the projected feature descriptors are scaled by a factor in order to obtain a respective feature descriptor vector composed of integers. Doing this, we changed the distance between the feature descriptors, but the matching result would be the same because all the descriptors are multiplied by the same scale.

According to another aspect, there is provided a feature descriptor configured to be used in matching at least one feature of an object representation, wherein the feature descriptor is describing at least one feature extracted from an object representation and is indicative of a selected region of interest around the extracted feature, which region is divided into sub-regions, comprising a feature descriptor vector containing information about at least one vector or a plurality of K vectors with concatenation of the vectors, with at least one respective vector for every sub-region, wherein the feature descriptor vector comprises vectors projected onto a lower dimensional space of H−1 or lower from a corresponding vector of H entries of an original feature descriptor.

For example, said object representation is an image of a camera, a CAD model, a drawing, a sound, an image of a depth camera, an image of a time-of-flight camera, or a set of images from a multi-camera system.

According to an embodiment, the feature descriptor vector is a truncated feature descriptor vector obtained by dismissing at least one entry of each of the vectors of the original feature descriptor vector.

According to another embodiment, the feature descriptor vector is a transformed feature descriptor vector containing information for correcting any distortion caused by the projecting of the original feature descriptor vector on a lower dimensional space.

Particularly, the feature descriptor vector contains information for keeping an equal influence of every vector entry in a distance computation of a succeeding matching process.

According to another aspect, there is provided a method of matching at least one feature of an object representation, comprising extracting at least one current feature from an object representation and providing at least one current feature descriptor for the extracted current feature, providing a plurality of feature descriptors as described above, and comparing the current feature descriptor with the plurality of feature descriptors for matching the at least one current feature.

According to an embodiment, comparing the current feature descriptor with the plurality of feature descriptors comprises calculating a similarity measure between the current feature descriptor and at least some of the plurality of feature descriptors, wherein calculating the similarity measure includes calculating sum-of-squared differences, SSD, using the mean-bound SSD algorithm.

In an implementation in which the object representation is a current image of a camera, the method may further include determining a position and orientation of the camera which captures the current image with respect to an object in the current image based on correspondences of feature descriptors determined in the matching process.

For example, the method of providing a feature descriptor is a method of providing a feature descriptor configured to be used in matching an object representation in an augmented reality application or a visual search application.

According to another embodiment, the e method of matching at least one feature is a method of matching at least one feature of an object representation in an augmented reality application or in a visual search application.

According to another aspect, there is also provided a computer program product adapted to be loaded into the internal memory of a digital computer system, and comprising software code sections by means of which the methods and steps as described above are performed when said product is running on said computer system.

### BRIEF DESCRIPTION OF THE DRAWINGS

Further advantageous features, embodiments and aspects of the invention are described with reference to the following Figures, in which:

FIG. 1 shows an illustration depicting an exemplary visual feature extraction,

FIG. 2 shows an example of sub-regions around the feature point extracting according to the example of FIG. 1,

FIG. 3 shows an illustration for explaining a histogram-based visual descriptor computation according to a standard approach,

FIG. 4 shows an illustration according to an embodiment of the invention providing a method of providing a feature descriptor with histogram-based visual descriptor size reduction.

### DETAILED DESCRIPTION OF THE INVENTION

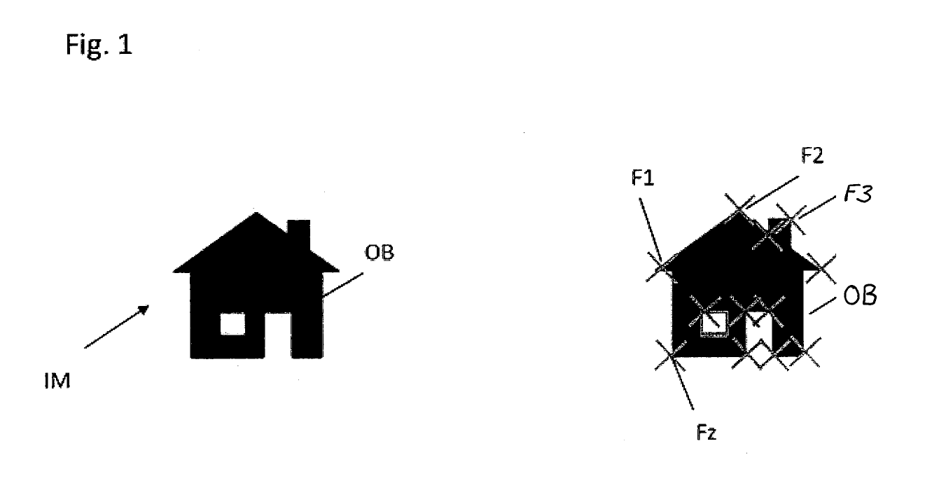

FIG. 1 shows an illustration depicting an exemplary visual feature extraction. Given a reference or a current image IM, for example captured by a virtual or real camera, with an object OB, features F1, F2, F3, . . . , Fz corresponding to pixel locations or a set of pixel locations in the image IM are extracted. Any of the above mentioned standard approaches may be used.

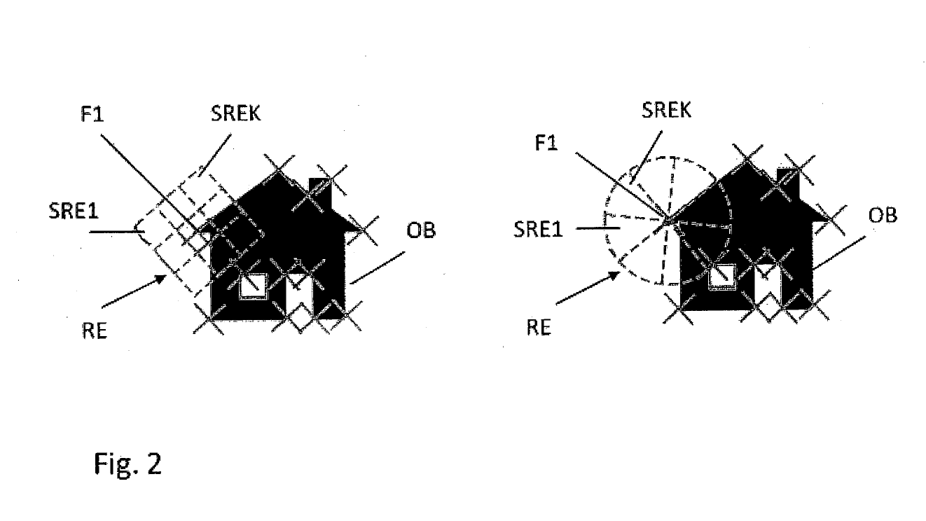

FIG. 2 shows Example of regions and sub-regions definition around one of the extracted features according to the example of FIG. 1, such as F1. Given a visual feature, such as feature F1, a region of interest RE around the feature is selected according to some feature orientation (square region RE in the left illustration and circular region RE in the right illustration). The region RE is divided into K sub-regions SRE1 to SREK (as an example, K=9 in the left illustration and K=8 in the right illustration) with equal number N of pixels.

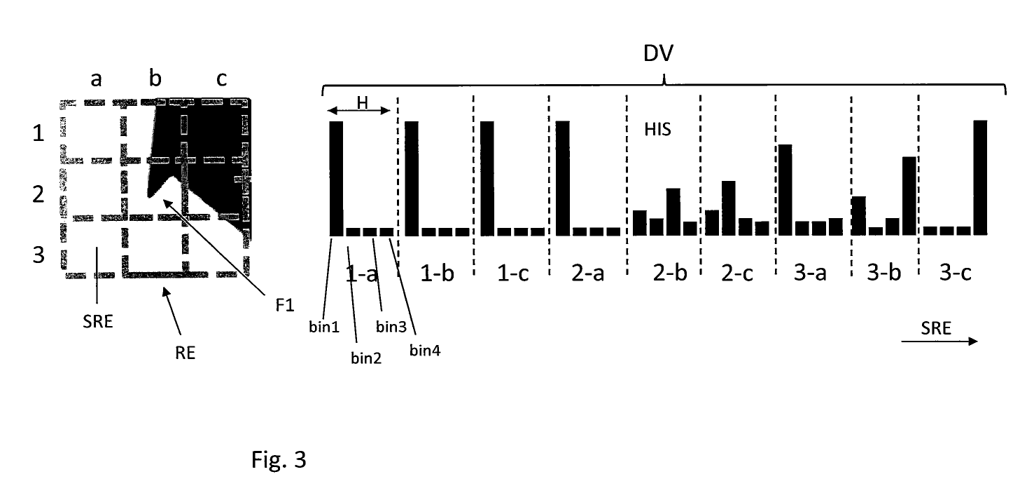

FIG. 3 shows an illustration for explaining an exemplary histogram-based visual descriptor computation according to a standard approach, such as one described above. For every sub-region SRE1-a to SRE3-c of the region of interest RE around a feature (here F1 as shown in FIG. 1), a respective histogram HIS1-a to HIS3-c is computed corresponding to a vector of size H (for example, H=4 in the FIG. 3). Particularly, the respective histogram HIS1-a to HIS3-c is containing finite values obtained with a function operating on an intensity value of a fixed set of neighbors of every pixel in the respective sub-region. The thus obtained feature descriptor vector DV comprises a plurality of K vectors (corresponding to the K histograms HIS1-a to HIS3-c), with each vector having equal sum of vector entry values and each vector having H entries. For example, the vector entries may be respective binned pixel intensity value comparisons as described herein, wherein in each of the vectors the sum of the vector entries is equal. Thus, feature descriptor vector DV according to FIG. 3 has a plurality of K vectors with H bins.

The visual feature descriptor vector DV is created with the concatenation of the histograms HIS1-a to HIS3-c of all sub-regions SRF1-a to SRE3-c. Thus, feature descriptor vector DV for feature F1 has a size of DS=K*H. Analogously, respective feature descriptor vectors DV are created for any remaining features F2 to Fz of the image IM.

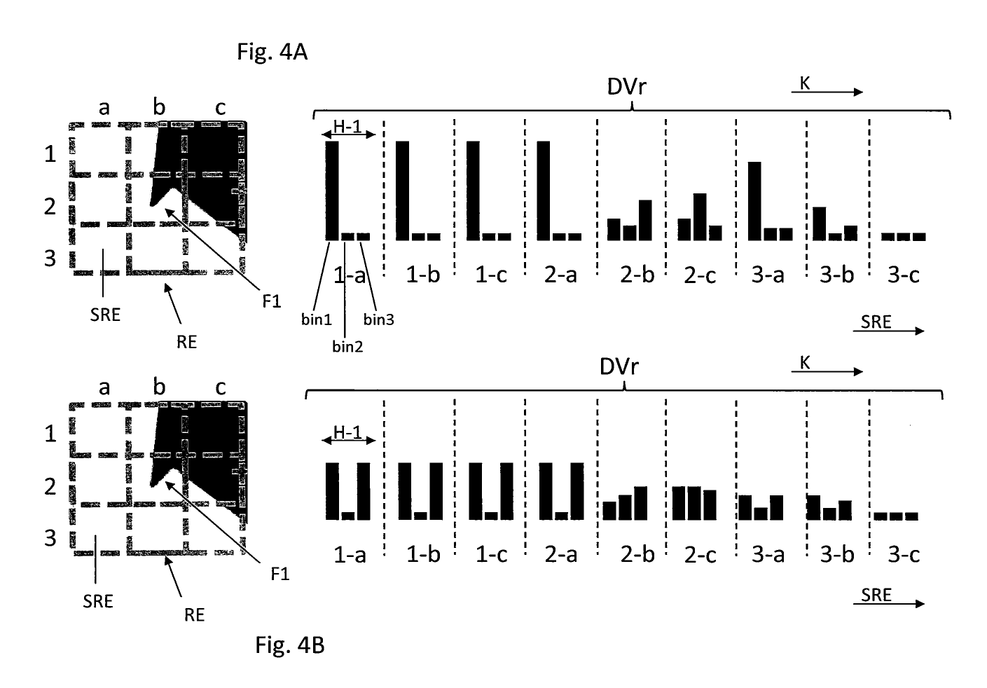

FIG. 4 shows an illustration according to an embodiment of the invention for illustrating a method of providing a feature descriptor with histogram-based visual descriptor size reduction.

The method starts with providing an original feature descriptor comprising at least one vector or a plurality of K vectors having equal sum of vector entry values and each vector having H entries. For example, an original feature descriptor may be the descriptor vector DV according to FIG. 3, for instance for feature F1 as an example, having a plurality of K vectors with H bins. In the following, when referring to a bin of a vector, it is referred to a respective feature vector entry which is in case of a histogram-based vector also referred to as bin. The following example is described with respect to such histogram-based feature descriptor. However, the invention is applicable to any kind of feature descriptor comprising at least one vector or a plurality of K vectors with equal sum of vector entries. According to the invention, each vector is projected on a lower dimensional space of size H−1 or lower, in the present example to size H−1=3, to gain a projected feature descriptor DVr of lower size compared to the original descriptor DV, such as shown in FIG. 4A or 4B, comprising projected vectors of H−1 entries or lower. Each of the K vectors is describing a respective sub-region SRE1-a to SRE3-c. The projection is made such that it is possible to obtain a similarity measure between two projected feature descriptors DVr equal to the similarity measure between the two corresponding original feature descriptors DV.

The FIG. 4A shows a first embodiment of the invention where the proposed approach dismisses from the original descriptor vector DV (as shown in an example in FIG. 3) at least one entry (here bin) of each of the K vectors. In the present example, bin4 is dismissed out of bin1, bin2, bin3 and bin4 of each local histogram vector HIS1-a to HIS3-c. Consequently, the size of the thus obtained truncated descriptor vector DVr (which is thus projected on a lower dimensional space) becomes: DSR K*(H−1). During a matching process, in order to have lossless results, the respective dismissed entry, here the last bin (i.e., that bin that has been dismissed with respect to the corresponding histogram HIS in FIG. 3), of each of the K vectors is recomputable, for instance could be recovered as

$$d ( k * H ) = N - {\sum }_{s = 1}^{H - 1} d ( ( k - 1 ) * H + s )$$

It is also possible to skip (dismiss) a different entry (bin) other than the last entry (bin). In the above example, it is also possible to skip bin1, bin2, or bin3 instead of bin4. For that purpose, the formula above needs to be adapted such that the skipped or dismissed entry is computed as
“N−the sum of the remaining entries of the respective one of the K vectors”.

FIG. 4B shows a second embodiment of the invention where the proposed approach transforms the original descriptor DV (as shown as an example in FIG. 3) to a reduced descriptor DVr in a way in order to keep an equal influence of every vector entry in a similarity measure computation of a succeeding matching process, in the present example to keep an equal influence of every histogram bin (bin1, bin2, bin3, bin4 in the present example) of the original descriptor DV, such as in the distance computation. The transformation corrects the distortion implied by the pure truncation. In this case, the distances are preserved and there is no need to recover the last bin (i.e. any dismissed entry) of each local histogram vector.

Referring to the embodiments described so far, it is proposed to use the known fixed size of the sub-regions used to compute the original feature descriptor to reduce the size of the descriptor. In a particular implementation, in the following it is referred to histogram-based feature descriptors. However, the invention may be implemented for any other type of feature descriptors as described above, with the following exemplary implementation being applied analogously.

As described above, the original visual feature descriptor vector of size K*H is projected on a lower dimensional space of size K*(H−1). The projection may be defined as follows

Let v₁ be a vector in the real H dimensional vector space R^{H} where

$${v}_{1} = {\frac{1}{\sqrt{H}} [ 1 \; 1 \; 1 … 1 ]}^{T} .$$

The vector v₁ defines an affine hyperplane of co-dimension 1: let p be a vector lying on such hyperplane, p verifies “the inherent sum constraint”:

$${v}_{1}^{T} \cdot p - \frac{N}{\sqrt{H}} = 0$$

The parts of the histogram-based visual feature descriptors that are associated to the different sub-regions (the sub-vectors) are on such hyperplanes (see above).

The vector v₁ can be completed by a set of H−1 orthonormal vectors vᵢin order to obtain an orthonormal basis of the R^{H} using e.g. the Gram-Schmidt process.

Using the vectors vᵢ, it is possible to project the every sub-vector of the histogram-based visual feature descriptors to a lower dimensional space spanned by vᵢ where i ∈ [2, H].

It should be noted that the method proposed in this invention applies to any feature descriptor vectors that are composed of the concatenation of a set of sub-vectors of equal sizes and where the sum of the entries of each sub-vector is the same. This means that there is no need to have the sub-vectors being the result of a histogram computation. This also means that the entries of the vectors do not need to be positive and do not need to be integer values and can be any non-integer (real) value. That is why the feature descriptors herein are referred to as histogram-“like”-based feature descriptors.

We give here two examples: H=3 and H=4. The person skilled in the art will know how to generalize the approach to a higher dimensional space.

The following is an example of how to reduce the dimension when sub-vectors are lying on a 3D hyperplane, preserving the distances:

Let p be a 3D vector lying on such hyperplane, p verifies:

$${v}_{1}^{T} \cdot p - \frac{N}{\sqrt{H}} = 0$$

where

$${v}_{1} = {\frac{1}{\sqrt{H}} [ 1 \; 1 \; 1 ]}^{T} .$$

All vectors on this hyperplane verify:

$$p = \frac{N}{\sqrt{H}} {v}_{1} + {αν}_{2} + {βν}_{3}$$

so that α, β are real numbers. The main idea is to represent the 3D vector p with a 2D vector [α β]^{T}.
v₂ and v₃ need to be normalized, pointing in the direction of the plane and need to be perpendicular to each other. These vectors can be computed with the Gram-Schmidt process using two additional initial vectors w₂ and w₃.

$${w}_{2} = [ \begin{matrix}1 \\ 0 \\ 0\end{matrix} ] {w}_{3} = [ \begin{matrix}0 \\ 1 \\ 0\end{matrix} ] {v}_{1} = [ \begin{matrix}1 / \sqrt{3} \\ 1 / \sqrt{3} \\ 1 / \sqrt{3}\end{matrix} ]$$

$${v}_{2} = {v}_{2}^{′} \cdot {‖ {v}_{2}^{′} ‖}^{- 1} = [ \begin{matrix}{v}_{2 , 1} \\ {v}_{2 , 2} \\ {v}_{2 , 3}\end{matrix} ] = [ \begin{matrix}\sqrt{6} / 3 \\ - \sqrt{6} / 6 \\ - \sqrt{6} / 6\end{matrix} ] ;$$

$${v}_{2}^{′} = {w}_{2} - \frac{{w}_{2} \cdot {v}_{1}}{{v}_{1} \cdot {v}_{1}} {v}_{1}$$

$${v}_{3} = {v}_{3}^{′} \cdot {‖ {v}_{3}^{′} ‖}^{- 1} = [ \begin{matrix}{v}_{3 , 1} \\ {v}_{3 , 2} \\ {v}_{3 , 3}\end{matrix} ] = [ \begin{matrix}0 \\ \sqrt{2} / 2 \\ - \sqrt{2} / 2\end{matrix} ] ;$$

$${v}_{3}^{′} = {w}_{3} = \frac{{w}_{3} \cdot {v}_{1}}{{v}_{1} \cdot {v}_{1}} {v}_{1} - \frac{{w}_{3} \cdot {v}_{2}}{{v}_{2} \cdot {v}_{2}} {v}_{2}$$

The parametric description can be described in a matrix notation.

$$p = [ \begin{matrix}x \\ y \\ z\end{matrix} ] = \frac{N}{\sqrt{H}} {v}_{1} + {αν}_{2} + {βν}_{3} = \frac{N}{\sqrt{H}} {v}_{1} + [ {v}_{2} {v}_{3} ] [ \begin{matrix}α \\ β\end{matrix} ]$$

Let M be the matrix defined using the entries of the vector v₂ and v₃ as:

$$M = [ \begin{matrix}{v}_{2 , 1} & {v}_{3 , 1} \\ {v}_{2 , 2} & {v}_{3 , 2}\end{matrix} ] = [ \begin{matrix}\sqrt{6} / 3 & 0 \\ - \sqrt{6} / 6 & \sqrt{2} / 2\end{matrix} ]$$

The inverse of the matrix M can be used to transform p to [α β]^{T}.

$$[ \begin{matrix}α \\ β\end{matrix} ] = {M}^{- 1} [ \begin{matrix}x \\ y\end{matrix} ] = [ \begin{matrix}\sqrt{6} / 2 x \\ \sqrt{2} / 2 x + \sqrt{2} y\end{matrix} ] ;$$

It is possible to demonstrate that the distances are preserved before and after projections. In fact,

$$‖ [ \begin{matrix}{α}_{1} \\ {β}_{1}\end{matrix} ] - [ \begin{matrix}{α}_{2} \\ {β}_{2}\end{matrix} ] ‖ = ‖ [ \begin{matrix}{x}_{1} \\ {y}_{1} \\ {z}_{1}\end{matrix} ] - [ \begin{matrix}{x}_{2} \\ {y}_{2} \\ {z}_{2}\end{matrix} ] ‖ when [ \begin{matrix}{α}_{1} \\ {β}_{1}\end{matrix} ] = {M}^{- 1} [ \begin{matrix}{x}_{1} \\ {y}_{1}\end{matrix} ] and [ \begin{matrix}{α}_{2} \\ {β}_{2}\end{matrix} ] = {M}^{- 1} [ \begin{matrix}{x}_{2} \\ {y}_{2}\end{matrix} ]$$

The same property holds in the targeted case of this invention which is when there is a concatenation of such 3D vectors. When every sub-vector of dimension 4 is projected as explained above, the distance is preserved.

Note that it is possible to multiply the resulting vector

$$[ \begin{matrix}α \\ β\end{matrix} ]$$

by a fixed scalar in order to get integer values. The usage of integer values is generally faster than the usage of (real non-integer) floating point values. This remark applies to any vector dimension.

The following is an example of how to reduce the dimension when points are lying on a diagonal 4D-hyper plane, preserving the distances:

In case of 4D the transformation is way easier. v₂, v₃, V₄ can be easily found by permuting the signs of the normalized diagonal vector v₁.

$${v}_{1} = [ \begin{matrix}1 / 2 \\ 1 / 2 \\ 1 / 2 \\ 1 / 2\end{matrix} ] {v}_{2} = [ \begin{matrix}1 / 2 \\ 1 / 2 \\ - 1 / 2 \\ - 1 / 2\end{matrix} ] {v}_{3} = [ \begin{matrix}1 / 2 \\ - 1 / 2 \\ 1 / 2 \\ - 1 / 2\end{matrix} ] {v}_{4} = [ \begin{matrix}- 1 / 2 \\ 1 / 2 \\ 1 / 2 \\ - 1 / 2\end{matrix} ]$$

M is computed accordingly to transformation [α β γ]^{T} to p.

$$M = [ \begin{matrix}{v}_{2 , 1} & {v}_{3 , 1} & {v}_{4 , 1} \\ {v}_{2 , 2} & {v}_{3 , 2} & {v}_{4 , 2} \\ {v}_{2 , 3} & {v}_{3 , 3} & {v}_{4 , 3}\end{matrix} ] = [ \begin{matrix}1 / 2 & 1 / 2 & - 1 / 2 \\ 1 / 2 & - 1 / 2 & 1 / 2 \\ - 1 / 2 & 1 / 2 & 1 / 2\end{matrix} ]$$

The inverse of M can be used to transform p to [α β γ]^{T}, but in the 4D case the transformation is way simpler:

$$[ \begin{matrix}α \\ β \\ γ\end{matrix} ] = {M}^{- 1} = [ \begin{matrix}x \\ y \\ z\end{matrix} ] = [ \begin{matrix}x + y \\ x + z \\ y + z\end{matrix} ]$$

Distances are also preserved such that

$$‖ [ \begin{matrix}{α}_{1} \\ {β}_{1} \\ {γ}_{1}\end{matrix} ] - [ \begin{matrix}{α}_{2} \\ {β}_{2} \\ {γ}_{2}\end{matrix} ] ‖ = ‖ [ \begin{matrix}{x}_{1} \\ {y}_{1} \\ {z}_{1} \\ {w}_{1}\end{matrix} ] - [ \begin{matrix}{x}_{2} \\ {y}_{2} \\ {z}_{2} \\ {w}_{2}\end{matrix} ] ‖ if [ \begin{matrix}{α}_{1} \\ {β}_{1} \\ {γ}_{1}\end{matrix} ] = {M}^{- 1} [ \begin{matrix}{x}_{1} \\ {y}_{1} \\ {z}_{1}\end{matrix} ] and [ \begin{matrix}{α}_{2} \\ {β}_{2} \\ {γ}_{2}\end{matrix} ] = {M}^{- 1} [ \begin{matrix}{x}_{2} \\ {y}_{2} \\ {z}_{2}\end{matrix} ]$$

As a result, according to the invention, the required memory of the descriptor storage is reduced. The reduction of the descriptor size has a direct positive influence on the memory efficiency since only part of the standard histogram-based feature descriptors needs to be stored. The obtained truncated feature descriptor requires a fraction (H−1)/H of the original descriptor size.

Further, the matching computational cost can be reduced. The similarity measure computation computational cost is proportional to the size of the visual feature descriptor vector. Since the obtained truncated feature descriptor requires a fraction (H−1)/H of the original descriptor size, the computational cost of the similarity measure computation is reduced by the same fraction.

The possible usage of the mean-bound-SSD:

Mean-bound-SSD (used in E. Rosten. High performance rigid body tracking. PhD thesis, University of Cambridge. February 2006) can speed up the process of finding the closest reference descriptor d=[d₁d₂ . . . d_{N}]^{T} to a descriptor extracted from the camera image ƒ such that

argminⱼ∥ƒ−(j)∥

In an offline step the reference descriptors D are sorted by their mean value. This is done once for a static set of reference descriptors.

A binary search is performed to find the reference feature with the closest mean to the camera descriptor ƒ. This step can be performed in O(log(n)) on this sorted list D

m=argminᵢ| ƒ̅− d̅ᵢ|

The SSD search is performed starting with descriptor dₘ and continued to the left and to the right by looping over the search index k. The BestSSD is initialized with ∞ and updated if a smaller SSD is found in further iterations on k.

BestSSD=min(∥ƒ−dₘ₊ₖ₋₁∥; ∥ƒ−dₘ₋ₖ∥; BestSSD)

### 2 Iterations on the Set D

| k | . . . | 3 | 2 | 1 | 1 | 2 | 3 | . . . |
|---|---|---|---|---|---|---|---|---|
| i | | m − 3 | m − 2 | m − 1 | m | m + 1 | m + 2 | |

The search can be restricted to the left and to the right with the mean bound condition: DS ( ƒ̅− d̅ᵢ)²≦∥ ƒ̅− d̅ᵢ∥² it reveals the minimal SSD error for a given mean difference between two descriptors. With this information the search to the left and to the right can be restricted according to the BestSSD so far.

If DS ( ƒ̅− d̅ₘ₊ₖ₋₁)²>BestSSD² stop further iterations on the right side and if DS ( f̅− d̅ₘ₋ₖ)²>BestSSD² stop further iterations on the left side.

The remaining SSD computations can be skipped as they have for sure a higher distance to the current descriptor than the already found BestSSD. The skipped SSD computations are responsible for the speedup.

Whenever a descriptor falls into “the inherent sum constraint”, it is impossible to benefit from the mean-bound-SSD approach anymore. The mean bound condition DS ( ƒ̅− d̅ᵢ)²>BestSSD² is based on the mean differences of two descriptors. It cannot be applied in the state-of-the-art histogram-based visual feature descriptor because ( ƒ̅− d̅ᵢ)²=0. No SSD computation can be skipped, as the mean bound condition 0>BestSSD² cannot be violated anymore.

However after the proposed reduction of the original descriptor size, the descriptor does not apply to “the inherent sum constraint”. This makes it suitable for the mean-bound-SSD approach and this provides a further matching speed-up.

While the invention has been described with reference to exemplary embodiments and applications scenarios, it will be understood by those skilled in the art that various changes may be made and equivalents may be substituted for elements thereof without departing from the scope of the claims. Therefore, it is intended that the invention not be limited to the particular embodiments disclosed, but that the invention will include all embodiments falling within the scope of the appended claims and can be applied to various application in the industrial as well as commercial field.

What is claimed is:

1. A method of providing a feature descriptor for describing at least one feature of an object representation, comprising the steps of:
a) providing an original feature descriptor comprising at least one vector or a plurality of K vectors having equal sum of vector entry values and each vector having H entries;
b) projecting each vector on a lower dimensional space of size H−1 or lower to gain a projected feature descriptor comprising projected vectors of H−1 entries or lower, such that it is possible to obtain a similarity measure between two projected feature descriptors equal to the similarity measure between the two corresponding original feature descriptors; and
c) providing the projected feature descriptor as a lossless compressed feature descriptor.

2. The method according to claim 1, wherein said object representation is an image of a camera, a CAD model, a drawing, a sound, an image from a depth camera, an image of a time-of-flight camera, or a set of images from a multi-camera system.

3. The method according to claim 1, wherein said object representation is an image of a camera, wherein step a) comprises the steps of:
aa) extracting at least one feature from the image;
ab) selecting a region of interest around the extracted feature;
ac) dividing the region of interest into one sub-region or K sub-regions;
ad) for every sub-region, computing a respective vector of H entries; and
ae) providing one vector or K vectors as the original feature descriptor for the extracted feature.

4. The method according to claim 3, wherein step ac) includes dividing the region of interest into K sub-regions with equal number N of pixels, and in the feature descriptor vector created in step ae) the sum of the values of all the entries of each vector in every sub-region is equal to N.

5. The method according to claim 3, wherein step ad) comprises computing a respective vector of H entries containing values obtained with a function operating on an intensity value of a set of neighbors of a plurality of pixels in the respective sub-region.

6. The method according to claim 5, wherein before computing the function results, a morphological image operation or filter, including at least one of an image gradient, image synthetic blurring, image de-noising, image smoothing, or image histogram enhancement, is applied.

7. The method according to claim 5, wherein the function is based on intensity comparisons for pixels in the respective sub-region.

8. The method according to claim 5, wherein the function is based on binned gradient orientations with each of a plurality of entries of the respective vector containing a number of pixels in the respective sub-region that have a particular gradient orientation.

9. The method according to claim 1, wherein step b) comprises dismissing at least one entry of each of the K vectors, wherein the number of entries of the obtained truncated feature descriptor vector becomes K*(H−1) or less.

10. The method according to claim 9, wherein in a subsequent similarity measure computation during the matching process the dismissed entry of each vector is recomputable.

11. The method according to claim 1, wherein step h) comprises transforming the feature descriptor vector in such a way to correct any distortion caused by the projecting of the feature descriptor vector on a lower dimensional space.

12. The method according to claim 11, wherein step b) comprises transforming the feature descriptor vector in such a way to keep an equal influence of every vector entry in a similarity measure computation of a succeeding matching process.

13. The method according to claim 1, wherein step b) includes the following steps:
providing a vector v₁ in R^{H} where
$${v}_{1} = {\frac{1}{\sqrt{H}} [ 1 \; 1 \; 1 … 1 ]}^{T} ,$$
wherein the vector v₁ defines an affine hyperplane of co-dimension 1, and providing a vector p lying on such hyperplane, wherein p verifies: v₁^{T}.
$$p - \frac{N}{\sqrt{H}} = 0 ;$$
completing the vector v₁ by a set of H−1 orthonormal vectors vᵢ in order to obtain an orthonormal basis of the R^{H} which is the real H dimensional vector space, particularly using the Gram-Schmidt process; and
using the vectors vᵢ in projecting the feature descriptor vector on a lower dimensional space spanned by vᵢ where i ∈ [2, H].

14. The method according to claim 1, wherein the projected feature descriptors are scaled by a factor in order to obtain a respective feature descriptor vector composed of integers.

15-19. (canceled)

20. A method of matching at least one feature of an object representation, comprising:
extracting at least one current feature from an object representation and providing at least one current feature descriptor for the extracted current feature;
providing a plurality of feature descriptors, wherein each feature descriptor is configured to be used in matching, at least one feature of an object representation, wherein the feature descriptor is describing at least one feature extruded from an object representation and is indicative of a selected region of interest around the extracted feature, which region is divided into sub-regions, and which feature descriptor includes:
a feature descriptor vector containing information about at least one vector or a plurality of K vectors with concatenation of the vectors of the sub-regions, with at least one respective vector for every sub-region; and
wherein the feature descriptor vector comprises vectors projected onto a lower dimensional space of (H−1) or lower from a corresponding vector of H entries of an original feature descriptor; and
comparing a first of the plurality of the feature descriptors with at least one of the other feature descriptors for matching the at least one current feature.

21. The method according to claim 20, wherein the step of comparing the first feature descriptor with at least one of the other feature descriptors comprises calculating a similarity measure between the current feature descriptor and at least some of the plurality of feature descriptors; and
wherein calculating the similarity measure includes calculating sum-of-squared differences (SSD), using a mean-bound SSD algorithm.

22. The method according to claim 20, wherein the object representation is a current image of a camera, the method further including determining a position and orientation of the camera which captures the current image with respect to an object in the current image based on correspondences of feature descriptors determined in the matching process.

23-24. (canceled)

25. A non-transitory computer readable medium comprising software code sections adapted to perform a method for providing a feature descriptor for describing at least one feature of an object representation, comprising:
a) providing an original feature descriptor comprising at least one vector or a plurality of K vectors having equal sum of vector entity values and each vector having H entries.
b) projecting each vector on a lower dimensional space of size H−1 or lower to gain a projected feature descriptor comprising projected vectors of H−1 entries or lower, such that it is possible to obtain a similarity measure between two projected feature descriptors equal to the similarity measure between the two corresponding original feature descriptors; and
c) providing the projected feature descriptor as a lossless compressed feature descriptor.

26. The method of claim 20, wherein said object representation is an image of a camera, a CAD model, a drawing, a sound, an image of a depth camera, an image of a time-of-flight camera, or a set of images from a multi-camera system.

27. The method of claim 20, wherein the feature descriptor vector is a truncated feature descriptor vector obtained by dismissing at least one entry of each of the vectors of the original feature descriptor vector.

28. The method of claim 20, wherein the feature descriptor vector is a transformed feature descriptor vector containing information for correcting any distortion caused by the projecting of the original feature descriptor vector on a lower dimensional space.

29. The method of claim 20, wherein the feature descriptor vector contains information for keeping an equal influence of every vector entry in a distance computation of a succeeding matching process.
